(19) United States
(12) Patent Application Publication
(10) Pub. No.: US 2006/0174031 A1
(43) Pub. Date: Aug. 3, 2006

(54) Data transmission among network-connected information processors

(75) Inventors: Naoki Yamakoshi, Yamato-Shi (JP); Tadashi Yamamoto, Yamato-Shi (JP); Hiroshi Katoh, Yamato-Shi (JP)

Correspondence Address: LENOVO (US) IP Law, Mail Stop ZHHA/B675/PO Box 12195, 3039 Cornwallis Road, RTP, NC, 27709-2195, US

(73) Assignee: Lenovo (Singapore) Pte. Ltd., Singapore (SG)

(21) Appl. No.: 11/263,878

(22) Filed: Nov. 1, 2005

(30) Foreign Application Priority Data
Nov. 1, 2004 (JP) 2004-317988

(51) Int. Cl. G06F 15/16

(52) U.S. Cl. 709/237

(57) ABSTRACT

An information processor includes a network adapter connected to a network for transmitting data at the data link layer level, and a setup processing section for recognizing the network adapter connected to the network within a memory, sending out a broadcast packet that requests a response at the data link layer level to the network via the recognized network adapter, verifying a response packet transmitted via the network, acquiring a hardware address and an IP address from the response packet, and thereby performing setup for data transmission at the data link layer level and the transport layer level, and automatically performing a data migration or exchange process between information processors.

### BACKGROUND OF THE INVENTION

The present invention relates to an information processor for transmitting data via a network, and in particular to an information processor for transmitting data for constructing a network environment to an information processor which is going to participate in an existing network environment, a data transmission system, a data transmission method and an information-processor-executable program for causing an information processor to perform the data transmission method.

Usually, there are many information processors connected to a network environment, and they share an application, a database, a printer and the like. Such a network environment enables the accomplishment of office activities to be more efficient and, therefore, recently has been a common form of connecting information processors to each other. Accordingly, demand for maintenance and management work of information processors connected to such a network environment and for replacement of the information processors is on the rise. When connecting a new information processor to a network, a user is required to perform operations of connecting the information processor to the network, recognizing it within the network, acquiring an unused IP address from a DHCP server or the like, and thereby performing setup for the network environment. Afterwards, the user connects the new information processor to a database server or a printer through a predetermined network path via the network, and then performs procedures such as those for installation of necessary application program/software.

When the procedures are performed, much time and labor is required for a user to set the environment for only one information processor directly managed by the user. Therefore, in order to replace all or a part of information processors arranged on desks of respective users in a company, connect them to a network at the deskside environment and enable works to be performed thereby, for example, significantly high time cost and labor cost are required of a user. Such high costs give a psychologically heavy burden when the user thinks of replacement of information processors. In the case of a service engineer who performs maintenance, the problem of cost and efficiency also occurs because much time and labor is consumed in maintenance.

If data for connection to a network can be transmitted to an information processor to be newly connected to the network from an information processor which has already been connected thereto, it is possible, by performing or establishing settings for only one information processor, for the new system to establish connection for other information processors in the same local area network (LAN), and thereby maintainability and usability of the network environment can be enhanced.

As a method for enabling data transmission between at least two information processors, there is disclosed in Specification No. 2546177 (Patent Document 1), for example, a method in which, if establishment of a data link between an online information processing program on one information processor and an online information program on another information processor fails, the one information processor causes its alternative communication line selection information means to repeatedly execute a data link establishment process so that a communication line is automatically selected. The method of Patent Document 1, however, is a process to be performed after communication is already enabled on a network and is not a technique for establishing transmission of data for establishing a network.

In Published Unexamined Patent Application No. 2002-197051 (Patent Document 2), there is disclosed a method for selecting a communication adapter in the case where a counterpart information processor equips multiple communication adapters. This method is also basically based on the premise that network configuration has already been performed for the counterpart information processor and is not a method for transmitting data to an information processor for which a network environment has not been set yet.

Furthermore, in Published Unexamined Patent Application No. 2004-252732 (Patent Document 3), there is disclosed a data sharing device for sending a broadcast packet to a different data sharing device having desired data and acquiring address information indicating the responding data sharing device and data name information so that the data can be shared via P2P-type communication. However, this device is also based on the premise that the data sharing devices are already in the same network environment, and there is not disclosed a protocol for establishing communication with another information processor that does not have configuration parameters for network connection.

In Published Unexamined Patent Application No. 2003-44560 (Patent Document 4), there is disclosed a transaction method of acquiring settings within a source information processor transferring the acquired data to a destination information processor to be purchased by a user and storing the settings and data in the destination information processor before providing the destination information processor for the user. Though this method is described as enabling transmission of information about a source information processor to a destination information processor, it is based on the premise that the setting is performed by the person or organization that provides the destination information processor and, therefore, the provided information processor has already been connectable to a network without any trouble. There is no disclosure about transmission of data for connection to a network to an information processor which has not been recognized with the network environment either. The data for connection to a network includes all data required for a user to make a physical connection, such as a subnet mask, a MAC address and the like in addition to an IP address, which are necessary to be transmitted via network. There is a possibility that this may cause serious security problems.

In a local area network, it is possible to get the MAC address corresponding to given IP address by using address resolution protocol (ARP) at the data link layer. However, the ARP is available only when the IP address is known and thus is not suitable for establishing a handshake connection between two information processors, with higher information reliability and with more information amount, when the IP address of the counterpart is not known yet. Furthermore, in the case of constructing a network environment on customers site, there is a possibility that the priority of network adapters set by each user for each information processor that has already been in use and connected to a network environment is different. In general, it is not applicable, from security management point of view, that a service provider unnecessarily checks or changes information about the personal information processor managed by a user in order to cope with the above problem.

Japanese Patent Documents:
[Patent Document 1]
Specification No. 2546177
[Patent Document 2]
Published Unexamined Patent Application No. 2002-197051
[Patent Document 3]
Published Unexamined Patent Application No. 2004-252732
[Patent Document 4]
Published Unexamined Patent Application No. 2003-44560

### SUMMARY OF THE INVENTION

Such disclosures are based on the premise that the process of establishing a network environment, for an information processor which has not yet been connected to a network, primarily is performed by a user or is performed by the manufacturer to the information processor being initialized based on manufacturer-acquired information.

Recently, it is common that an information processor equips multiple communication adapters such as a dial-up adapter, a wireless LAN adapter and an Ethernet® adapter. Furthermore, it is also common that which adapter should be given priority or what adapters are included vary depending on user settings. This is also the reason why onsite configuration process of network environment is often performed by the users themselves.

One purpose of the present invention is to provide an information processor for enabling establishment of a network path for an information processor which does not have parameters for connection to a network environment though physically connected to the network environment and automatic acquisition of the data for participation in the network environment, a data transmission system, a data transmission method and an information-processor-executable program for causing an information processor to perform the data transmission method.

Applicants have discovered that, if it is possible to automatically set network parameters on site for an information processor which is not connected to a network environment or which needs to connect to a new network environment, the time and labor required for a user and a service engineer can be reduced, and thereby maintenance work for information processors can be performed more efficiently.

That is, embodiments of the present invention enable a network adapter available for the connection to a network to be automatically recognized from among multiple network adapters which are usually equipped. After that, by using broadcast at the data link layer level to discover the peer information processor to which the establishment of network connection is required, and by using an IP address generated temporarily to perform data transmission at the transport layer level, network configuration parameters are transmitted to the discovered information processor with high reliability and efficiency.

A broadcast packet in the present invention includes information about the sender of the packet. In a particular embodiment, the receiver information processor refers to the IP address of the sender and generates a temporary IP address close to the IP address. In another embodiment, a broadcast packet includes at least a subnet mask information. When receiving the broadcast packet, receiver information processor uses the subnet mask and the sender IP address to give a network adapter a temporary IP address which is effective only during a process to be performed via a network, and sends a UDP handshake packet as a response to the broadcast packet, that is, a response packet to the sender information processor (master information processor).

The information processor which has sent out the broadcast packet (the master information processor) analyzes and verifies the content of the handshake packet. If determining that the handshake packet is valid as a result of verification, the information processor generates a handshake response packet, stores the verification result in the handshake response and sends back the handshake response to the information processor which has sent out the handshake packet with the identified network adapter.

According to the configuration described above, it is possible to provide an information processor, capable of transmitting data for connection to a network, to other information processor or processors in a one-to-one environment, multiple one-to-one environments, or a one-to-N environment, efficiently and with a high security, only by establishing a LAN environment for at least one information processor, even in a network environment to which a lot of information processors usually equipped with multiple network adapters are connected, a data transmission system, a data transmission method and a information-processor-executable program for causing an information processor to perform the data transmission method. As a result, it is possible to reduce the amount of work and the cost required by a user who has to replace multiple information processors at once and labor required from a service engineer who performs maintenance and inspection of information processors. Thereby, it is possible to smoothly perform replacement of information processors and thereby improve maintenance cost and efficiency.

### BRIEF DESCRIPTION OF THE DRAWINGS

Some of the purposes of the invention having been stated, others will appear as the description proceeds, when taken in connection with the accompanying drawings, in which:

FIG. 1 shows the overview of functional structure of an information processor of the present invention;

FIG. 2 shows the structure of the information processor of the present invention by the OSI reference model;

FIG. 3 shows an embodiment of connection between two information processors in the case of performing data transmission in accordance with the present invention, and the functional structure thereof;

FIG. 4 is a flowchart showing a data transmission method of the present invention performed by a master information processor;

FIG. 5 is a flowchart showing a process of the data transmission method of the present invention performed by a slave information processor;

FIG. 6 shows a pseudo-code of a program to perform the process in FIG. 4 by the master information processor in the present invention;

FIG. 7 shows a pseudo-code of a program to perform the process in FIG. 5 to be performed by the slave information processor;

FIG. 8 shows embodiments of a connection request used in the present invention;

FIG. 9 shows an embodiment of a handshake packet transmitted from the slave information processor;

FIG. 10 shows an embodiment of a handshake response transmitted from the master information processor;

FIG. 11 shows an embodiment of a data transmission system to perform only the essential part of the data transmission method of the present invention;

FIG. 12 shows embodiments of a data transmission system to perform multiple one-to-one data transmissions in the present invention; and

FIG. 13 shows an embodiment of a data transmission system for performing one-to-N data transmission in the present invention.

### DETAILED DESCRIPTION OF THE ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

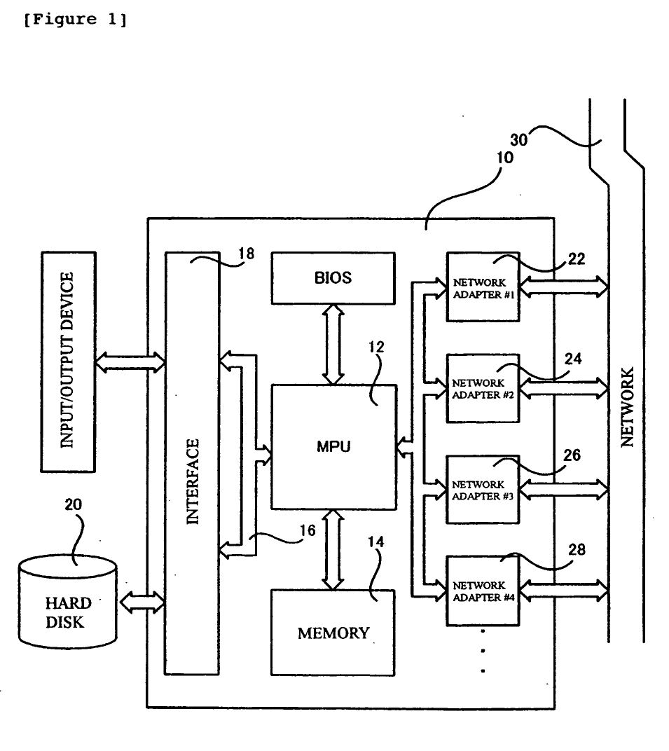

Referring now more particularly to the accompanying drawings, in which like numerals indicate like elements or steps throughout the several views, FIG. 1 shows a schematic functional structure of an information processor 10 of the present invention. As the information processor 10 shown in FIG. 1, a personal computer such as a laptop computer and a desktop personal computer, a workstation or the like can be used. In addition to an information processor on which an operation system (OS) such as Windows® XP, Windows® 2000 and Windows® Server could be running, this invention is applicable to an appliance server. More specifically, the information processor 10 includes a central processing unit (MPU) 12 and a memory 14, executes various applications, receives input from the outside via an interface 18 connected thereto with an internal bus 16, performs processing and stores the result in a storage device, for example a hard disk drive 20.

The central processing unit 12 monitors and manages each peripheral device by means of BIOS written in a ROM or the like, and controls each of network adapters 22, 24, 26 and 28 via the internal bus 16 to connect the information processor 10 to a network infrastructure 30 such as a local area network (LAN), a wide area network (WAN) and the Internet. The network adapters 22 to 28 are implemented in the information processor as board and/or cards corresponding to networks of multiple kinds of hardware specifications, such as an Ethernet® card, an optical communication board, a wireless communication devices and a dial-up adapter. The priority, the types, and the number of network adapters usually vary according to the individual user's setting or the design of the information processor 10.

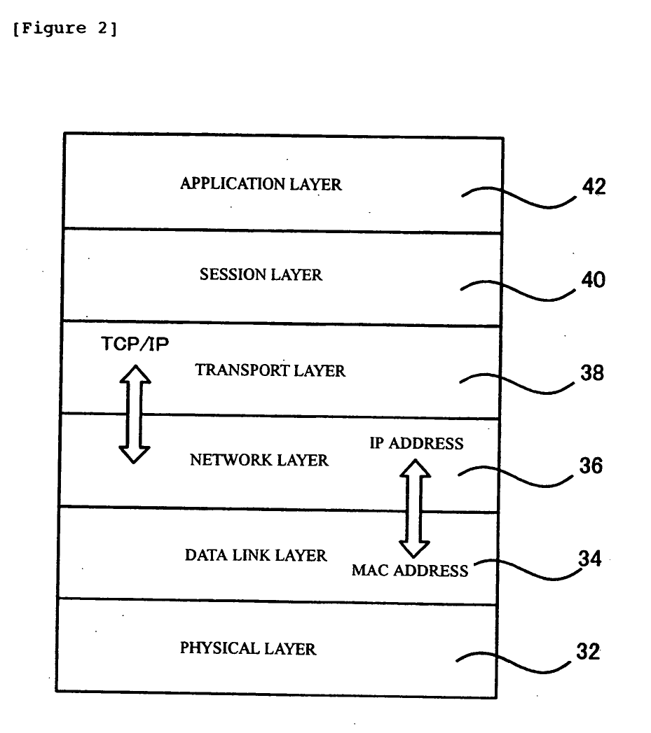

FIG. 2 shows the configuration of the information processor 10 of the present invention with the OSI reference model. As shown in FIG. 2, the information processor 10 includes a physical layer 32 which is the first layer, a data link layer 34 which is the second layer and a network layer 36 which is the third layer. Once an IP address is set and a network parameters are properly configured, data acquired via network layer is transmitted to higher layers such as a transport layer 38, a session layer 40 and an application layer 42, information or devices through a network environment can be shared. However, when a user purchases an information processor, the information processor does not have the information required for connection to the particular a network yet and does not have an IP address value for the particular network. Therefore, it is basically impossible to take advantage of reliable protocol with flow control such as TCP/IP. Accordingly, it is necessary to provide a method for automatically establishing a communication link capable of data transmission within the data link layer 34.

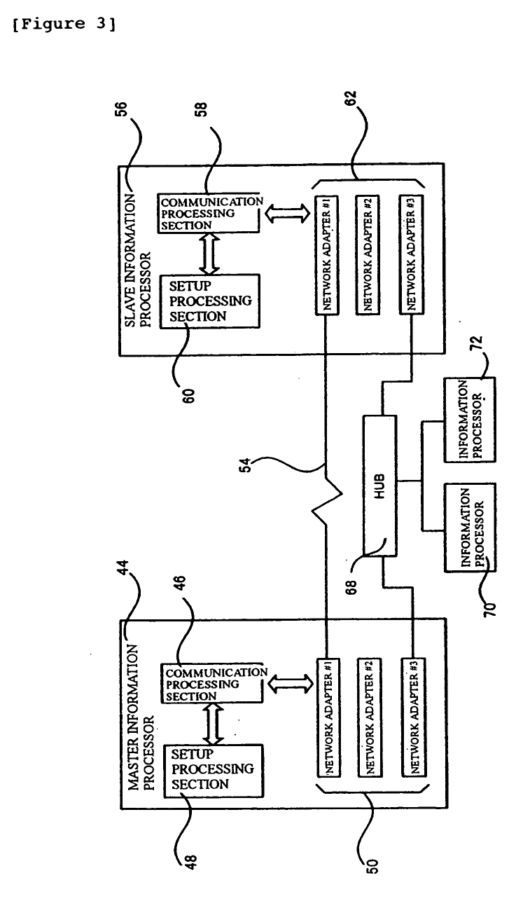

FIG. 3 shows an embodiment connecting two information processors 44 and 56 in the case of performing data transmission in accordance with the present invention, and the functional structure thereof. In FIG. 3, it is assumed that the information processor 44 (hereinafter referred to as a master information processor) is already connected to a network and holds for connection to the network and is required to transmit that information to the other information processor 56 (hereinafter referred to as a slave information processor).

The master information processor 44 includes a setup processing section 48 that is provided as application software for performing a data transmission method of the present invention, a communication processing section 46 that manages network adapters and includes a protocol provided supplied by the OS, and the network adapters #1 to #3 managed and controlled by the communication processing section 46. It is common that multiple network adapters are equipped with an information processor, and the present invention can be applied to the case of more or fewer network adapters than the number of the adapter in the FIG. 3. The functional structure of the slave information processor 56 is similar to that of the master information processor 44.

In the particular embodiment shown in FIG. 3, the master information processor 44 and the slave information processor 56 are connected to other information processors 70 and 72 via hub 68 over a LAN. However, in this situation, the slave information processor 56 is not functional as the LAN client though it is physically connected thereto. As shown in FIG. 3, in the most basic embodiment of the present invention, a communication link enabling data transmission of the present invention is configured by connecting, for example, the network adapters #1 (Ethernet®) which are not connected to LAN with each other via a cross over cable 54. In another embodiment of the present invention, 1 to N data transmission can also be performed among information processor via the hub 68 to the slave information processors that are connected to the LAN with the hub 68.

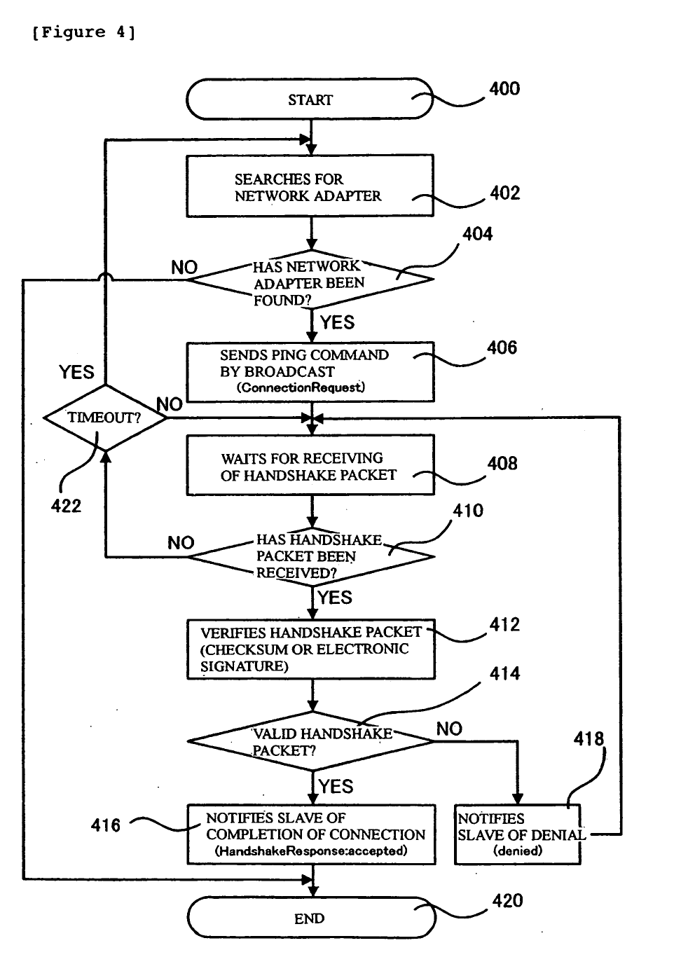

FIG. 4 is a flowchart showing the data transmission method of the present invention to be performed by a master information processor of the present invention. The process in FIG. 4 starts at step 400 and searches for a network adapter at step 402. The search for a network adapter is a process performed in order to cope with the case where the network adapter #1 shown in FIG. 3 is not given the highest priority among the adapters of master information processor by a user. At step 402, for example, by looking up a list of network adapters equipped with the master information processor, an Ethernet® card is searched for in the embodiment being described.

If the appropriate network adapter is discovered at step 404 (yes) after step 402 is executed, then the address information of the network adapter is acquired and stored in a storage device such as memory so that the search is no more required in subsequent data communication. Then, the master information processor sends out connection request from the network adapter as a broadcast. The connection request is a command for establishing link with a slave information processor. A special format of packet can be used as the connection request, or any known packet format, such as Ping, can be used if it can be transmitted as a broadcast packet. The structure of the broadcast packet, which is sent as a connection request in the present invention, and the structure of a handshake packet, which is a response packet to the broadcast packet will be described in detail in the later sections.

Returning to the flowchart in FIG. 4, at step 408, the process waits until a handshake packet corresponding to the connection request it has sent out is received. At step 410, when receiving a packet in the UDP format, for example, which is destined to a particular port of the master information processor in response to Ping (yes), then the process recognizes it to be a handshake packet. At step 412, it is examined whether the handshake packet is in a correct format by verifying the checksum, and it is also verified, with the connection identifier and signature provided by the sender of the handshake packet, whether the sender is a valid peer being connected. This process is required to coordinate transactions and perform proper operations when there are multiple slave information processors and multiple handshake packets have been received from the multiple apparatuses; to protect an information processor from a malicious attack from a different network pretending a handshake packet; and to prevent interference among master-slave communications when there are multiple master-slave information processors performing one-to-one data transmission.

At the same time, it is possible to determine which connection request sent by the master information processor the handshake packet corresponds to, with the use of a connection identification value in the handshake packet. This determination can be omitted when setup is performed in a one-to-one pseudo-P2P environment. However, when setup is performed in a one-to-N environment or when multiple one-to-one pseudo-P2P connection of the present invention are performed in the same LAN, the determination can be made based on whether or not a connection identification value included in a connection request is included in a handshake packet in the UDP format. In the present invention, when multiple handshake packets are detected, a process of selecting only the handshake packet which arrives the earliest and discarding other packets can be performed. In another embodiment, it is possible to use a FIFO buffer or the like to store incoming handshake packets in the FIFO buffer and sequentially process them.

If it is verified that the handshake packet is valid at step 414 (yes), then at step 416, a handshake response with a result code of verification, for example, result=accepted written therein is sent to the slave information processor. Then, at step 420, the data transmission method of the present invention is completed. After that, the master information processor automatically sends the data to be sent, to the slave information processor.

If a network adapter is not found at step 404 of the flowchart in FIG. 4 (no), there is a possibility that an Ethernet® card is not equipped or not functional. Therefore, the process branches to step 420 and ends. If a handshake packet cannot be received at step 410 (no), then it is required to determine whether it is only because it takes time to receive the handshake packet, or there are multiple network adapters of the same kind and another network adapter must be selected from the network adapters of the same kind, or a quite different kind of network adapter must be selected. Therefore, the process proceeds to step 422, where it is determined whether it is timed out or not. Until the timeout (no), then the process returns to step 408 to wait for arrival of the handshake packet. If it is timed out (yes), then the process returns to step 402 to look up different network adapter which is available.

If the handshake packet is not a valid handshake packet at step 414 (no), then the process branches to step 418 to generate a handshake response, with a denial value, for example, result=denied as a result code, and notify the slave information processor of the denial. Then, the process returns to step 408 to wait for a valid handshake packet sent back from the slave information processor.

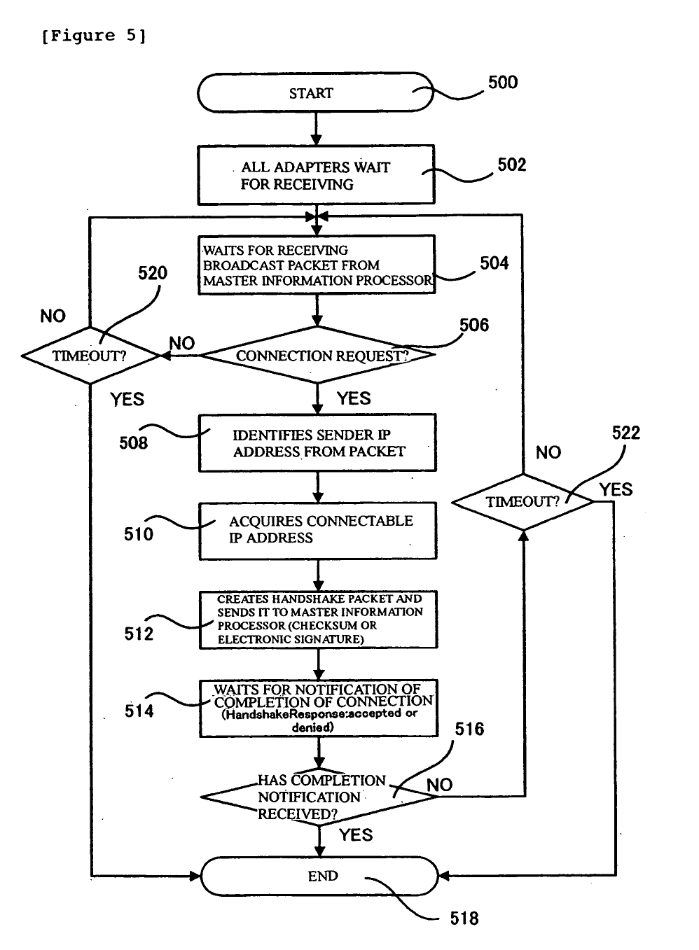

FIG. 5 is a flowchart showing the process of the data transmission method of the present invention performed by a slave information processor. The process shown in FIG. 5 starts at step 500, activates all the adapters at step 520 to prepare for receiving a connection request from a master information processor and waits for a connection request from the master information processor at step 504. At step 506, when it receives a broadcast packet, the process determines whether or not the broadcast packet is a connection request. The determination whether or not the broadcast packet is a connection request is not required to establish one-to-one connection and can be skipped. However, when setup is performed in multiple one-to-one environments or a one-to-N environment, the determination is required to distinguish the broadcast packet from broadcast packets issued by the other information processors.

More specifically, if the two information processors concerned are connected without other systems but via a single network adapter, then this determination can be made by checking a destination HW address to be described later to determine whether the broadcast packet is a broadcast packet at the data link layer level, for example, with a HW address of FF.FF.FF.FF.FF.FF when the network adapter is in accordance with the Ethernet® standard. In the case of other data link formats, a broadcast address differently specified can be used. When any other information processor than the two peer information processors are connected to the LAN, when the topology is one-to-N, or when there are multiple one-to-one pairs of master/slave information processors, the determination can be made by checking the consistency of the checksum in the payload of the received connection request as described later. In the case the connection request is in the UDP packet, the determination can be made by determining whether or not the destination IP address is an IP broadcast packet, whether a subnet mask is included in the UDP datagram or the like, in addition to the determination described above. If the broadcast packet is a connection request (yes), then the MAC address, the IP address of the sender, and the identification information of the master information processor about the sender are acquired from the received packet at step 508. Furthermore, at step 510, the slave information processor refers to the IP address of the master information processor and randomly selects neighborhood IP address close to the IP address of the master information processor. Alternatively, the IP address available in the LAN is generated and given to the network adapter concerned with the user of the IP address of the master information processor and the received subnet mask.

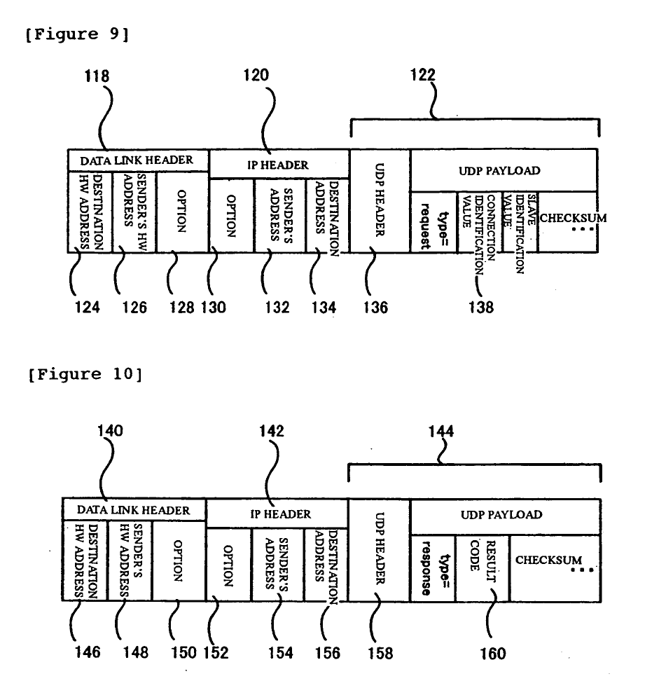

At step 512, a handshake packet is created and sent to the master information processor. In this case, by including identification information about the slave information processor in the handshake packet, it is possible to improve identifiability and checkability in setup for multiple one-to-one environments and a one-to-N environment. At the same time, a checksum or an electronic signature such as RSA or the like can be included in the handshake packet to improve checkability in the master information processor. The detailed structure of a handshake packet will be described in more detail with reference to FIG. 9.

At step 514, the process waits for receiving a handshake response from the master information processor. At step 516, when receiving a handshake response (yes), the process in FIG. 5 ends after acquiring the result code, result=( ), and making determination if the process is successfully done. Then, the process proceeds to preparation for transmission of the network data, other resource data and the like.

If a handshake response cannot be received at step 506 (no), then it is determined whether it is timed out or not at step 520. If it is timed out (yes), then the process branches to step 518 and is terminated. If it is not timed out yet (no), then the process returns to step 504 to further wait for receiving a handshake response. If a handshake response cannot be received at step 516 (no), it is conceivable that some trouble has been caused on the master information processor side or that processing on the master information processor side is simply delayed. Therefore, it is determined at step 522 whether it is timed out or not. If it is timed out (yes), then the process branches to step 518 and is terminated. If it is not timed out yet (no), then the process returns to step 504 to wait for a handshake response.

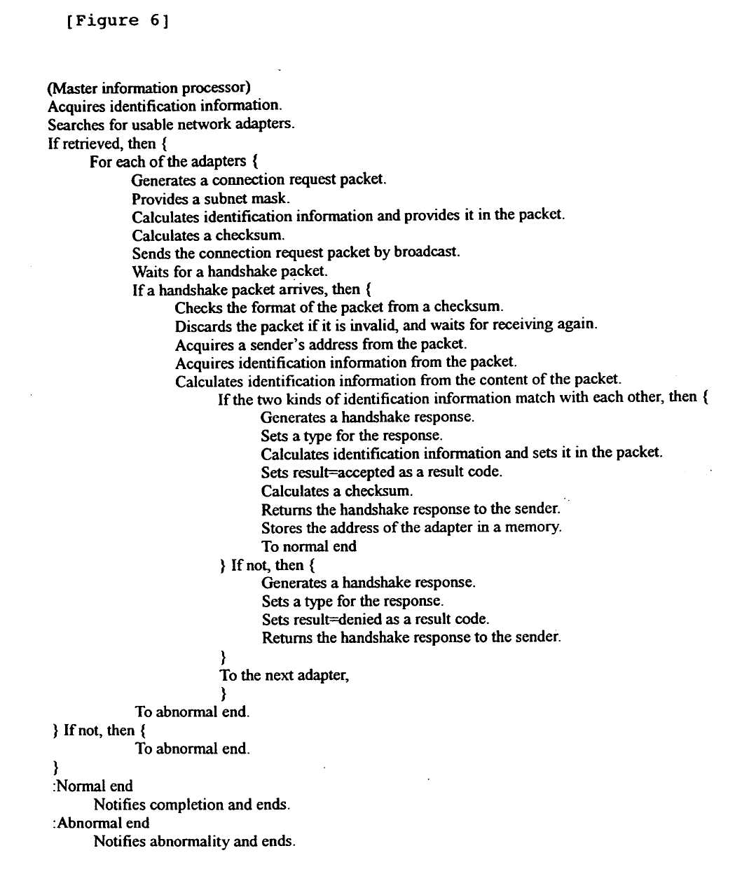

FIG. 6 shows a pseudo-code of a program for performing the process in FIG. 4 performed by a master information processor in the present invention. In the pseudo-code shown in FIG. 6, identification information about the master information processor is acquired or generated first, and then available network adapters are listed up. After that, connection requests to the network adapters are sequentially created. In the case of using a packet in the UDP format, a subnet mask, identification information, a checksum or an electronic signature data, and the like are also stored in the connection request in addition to data related to the data link layer and data related to the network layer, and the connection request is sent out.

In a particular embodiment, when a handshake packet arrives, validity check is performed with the checksum and the identification information sent by the master information processor. After that, when validity is examined by checking the identification information, a handshake response is generated, and identification information is calculated again and set in the handshake response. A value of acceptance, result=accepted, is written as a result code. Then, the handshake response is sent to the slave information processor together with a checksum, and the process ends.

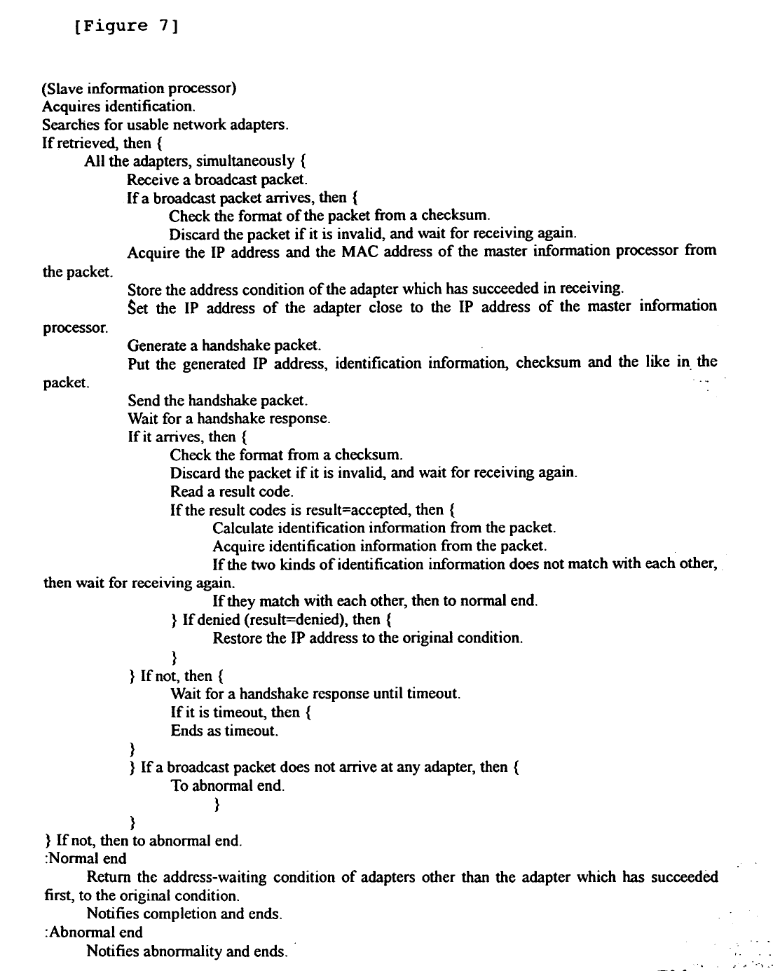

FIG. 7 shows a pseudo-code of a program for performing the process in FIG. 5 to be performed by a slave information processor. On the slave information processor side also, identification information is acquired and usable network adapters are retrieved first. The usable network adapters are caused to wait for receiving a connection request at the same time. After that, the format of a connection request is checked with a checksum. If the format is not appropriate, the connection request is discarded, and the network adapters wait for receiving again. If the format is appropriate, then the HW address and the IP address of the master information processor are acquired from the packet. Furthermore, the address condition of a network adapter which has succeeded in receiving is stored so that the network adapter is fixed for communication to be performed subsequently. After that, by setting the IP address of the slave information processor close to the IP address of the master information processor or by using a received subnet mask value to calculate the IP address of the master information processor in the LAN, a neighborhood IP address is generated. Then, the identification information and the MAC address, the IP address and the like of the slave information processor are stored to the handshake packet, and the packet is sent out to the master information processor. After verification with the checksum, the process ends.

The sequence of connection request, handshake and his response ends in accordance with the above process, both of the master information processor and the slave information processor have acquired the MAC address and the IP address of the peer and the identification information about communicable adapters of the peer, and are in a condition communicable at the transport layer which is above the data link layer.

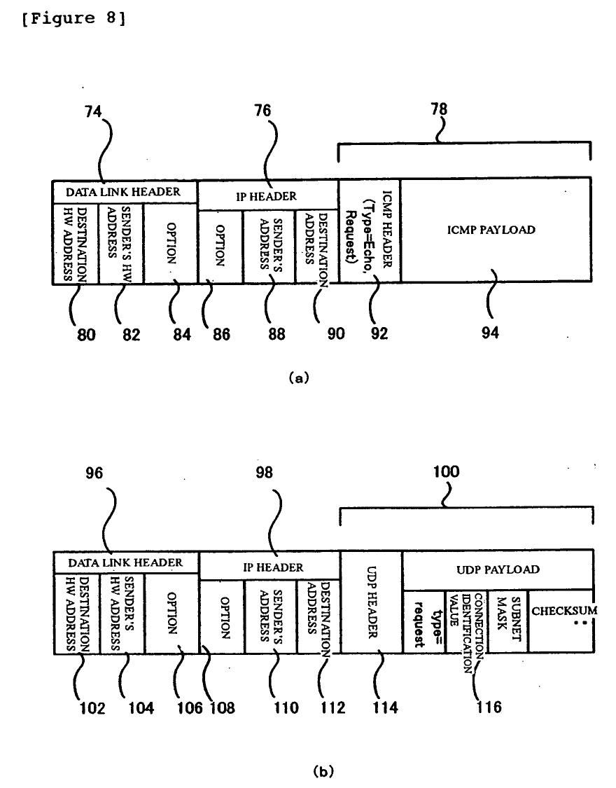

FIG. 8 shows embodiments of a connection request used in the present invention. FIG. 8(a) shows an embodiment in the case broadcast at the data link layer as a connection request, which has been generated by sending the ICMP ECHO command to the broadcast address of a network with the use of the Ping program shipped with the OS. FIG. 8(b) shows an embodiment in the case of storing necessary data in a connection request with the use of the UDP (user datagram protocol).

First, referring to FIG. 8(a) the connection request of this embodiment consists of a data link header 74, an IP header 76 and an ICMP data area 78 including an ICMP header and an ICMP payload. A destination hardware address (destination HW address) 80, specifically a MAC address, is written in the data link header 74. The data link header 74 also includes a sender's hardware address (sender's HW address) 82 and an optional area 84, an area in which additional information is stored. Since in this embodiment, it is assumed that the information about the peer is not known at the beginning of connection, a broadcast address at the network layer is set to the destination HW address to generate a broadcast packet at the data link layer level. In the case of Ethernet® standard as a particular embodiment, FF.FF.FF.FF.FF.FF is written as the broadcast address. The MAC address of the sender is written in the sender's HW address 82, and additional information is written in the optional area if required. These processes are automatically performed by a protocol stack of the OS. When a different network standard other than Ethernet® is used in this embodiment, a broadcast address defined by the network standard will be used.

The IP header 76 also includes an optional area 86, a sender's address 88 and a destination address 90. In the sender's address 88, the IP address of a master information processor is stored. In the destination address 90, the IP broadcast address is stored because at least the master information processor has been notified of the broadcast address at the network layer. In a particular embodiment of the present invention, abc.def.1.255 is written for the IP address of abc.def.1.0/255.255.255.0. An ICMP portion 78 includes an ICMP header 92 which describes the type of the packet and a payload 94. In the payload portion 94, specification of a command such as Ping is described as usually done.

The connection request shown in FIG. 8(a) is in a packet format which can be appropriately used for the most basic embodiment in which generally one slave information processor is connected to one master information processor via a cross cable, and the master information processor is not required to process handshake packets from multiple slave information processors. However, if there is no other information processors involved in P2P connection of the present invention within a network, one-to-N data transmission can be performed using the packet format shown in FIG. 8(a).

FIG. 8(b) shows another embodiment of a connection request of the present invention. A packet in the embodiment shown in FIG. 8(b) includes a data link header 96, an IP header 98 and a UDP portion 100. The configurations of the data link header 96 and the IP header 98 are similar to those described with reference to FIG. 8(a). The UDP portion 100 consists of a UDP header 114 and a UDP payload 116. For example, the format of the packet is described in the UDP header 114. In the UDP payload 116, information for multiple one-to-one data transmissions or a one-to-N data transmission is described. In a particular embodiment of the present invention, the data in the UDP payload includes a type identification value indicating that the packet is a connection request, a connection identification value, a subnet mask value, master information processor identification information for preventing interference and distinguishing a particular master information processor from other master information processors which may separately operate the process of this invention at the same time, a checksum or an electronic signature, and the like.

The connection identification value may be a value unique to one connection request. It is also possible to generate a timestamp when the connection request is issued by the master information processor and use it as the connection identification value. If the size of the program or the data is not limited in the present invention, it is also possible to generate and use a different value. The master information processor identification information may be a value of a random number if the master information processor can be identified by the value. It is also possible to use a value generated from information which is unique to the master information processor or the slave information processor, such as a MAC address with the use of an appropriate digest algorithm.

In order to establish one-to-one connection for data transmission, the computer name of the master information processor specified and given by the user can also be used. The checksum value is used to verify whether the packet format is correct. An electronic signature with the RSA algorithm or the like can be used to prevent tampering of data or malicious attacks from other hosts during data transmission. The electronic signature is not required in the present invention if there is not a possibility of tampering of data or attacks from other hosts.

FIG. 9 shows an embodiment of a handshake packet sent from a slave information processor in the present invention. The handshake packet shown in FIG. 9 is almost the same UDP packet shown in FIG. 8(b) and includes a data link header 118, an IP header 120 and a UDP portion 122. The data link header 118 includes a destination HW address 124, a sender's HW address 126 and an optional description portion 128. In the destination HW address 124, the MAC address of a master information processor sent from the master information processor is obtained from a connection request and described. In the sender's HW address 126, the MAC address of the slave information processor is described. In a destination address 134 of the IP header 120, the IP address of the master information processor read from the connection request is described. The sender's address can be generated as a neighborhood value close to the IP address of the master information processor in the case of one-to-one data transmission. In another embodiment of the present invention, it is possible to use the IP address and the subnet mask sent from a master information processor to generate an IP address which can be sent to the master information processor and write the generated IP address in a sender's address 132.

The UDP data description portion 122 includes a UDP header 136 and a UDP payload 138. In the UDP header 136, the format of the UDP payload 138 and the like are specified. In the UDP payload 138, a type identifier indicating that the packet is a handshake packet, a connection identification value read from a connection request, slave information processor identification information for preventing interference, and a checksum or an RSA electronic signature are described, which is similar to a connection request. The handshake packet shown in FIG. 9 is sent to the network and received by the master information processor.

The master information processor receives the handshake packet, and verifies the data from the checksum or the electronic signature and the like, and after this verification, acquires the MAC address and the IP address of the slave information processor from the corresponding areas of the handshake packet. After that, the master information processor sends a handshake response (packet) to the slave information processor in which the result of verification of the received handshake packet and the like are described.

FIG. 10 shows an embodiment of a handshake response sent from the master information processor. The handshake response is described in the UDP format and consists of a data link header 140, an IP header 142 and a UDP data description portion 144, almost the same as shown in FIG. 8(b).

The handshake response shown in FIG. 10, however, has described a type identification value indicating that the packet type is a handshake response, a result code value (result=( )), which is the result of verification on the master information processor side, a connection identification value, a checksum and the like in a UDP payload 160 included in the UDP data description portion 144. On the slave information processor side, the checksum in the UDP payload 160 is examined to check the packet is valid. Then, the type identification value is read, and from the result code value, the response from the master information processor to the handshake packet is determined. Then, the slave information processor starts setup for receiving and processing of data to be subsequently sent by the master information processor. In the present invention, as examples of data to be transmitted from a master information processor after the setup process, there is data for supporting a process of migrating data retained by the master information processor, such as data in a RAM managed by the master information processor, data stored in a hard disk and at least one kind of back-up data, to a slave information processor in order to support the use of the slave information processor by a user, in addition to addresses of a database server, a printer server and a mail server, an address of a DNS server and URL of a particular Internet site. In the present invention, however, transmitted data is not limited to the above, and any other data that can be transmitted between a master information processor and a slave information processor can be included.

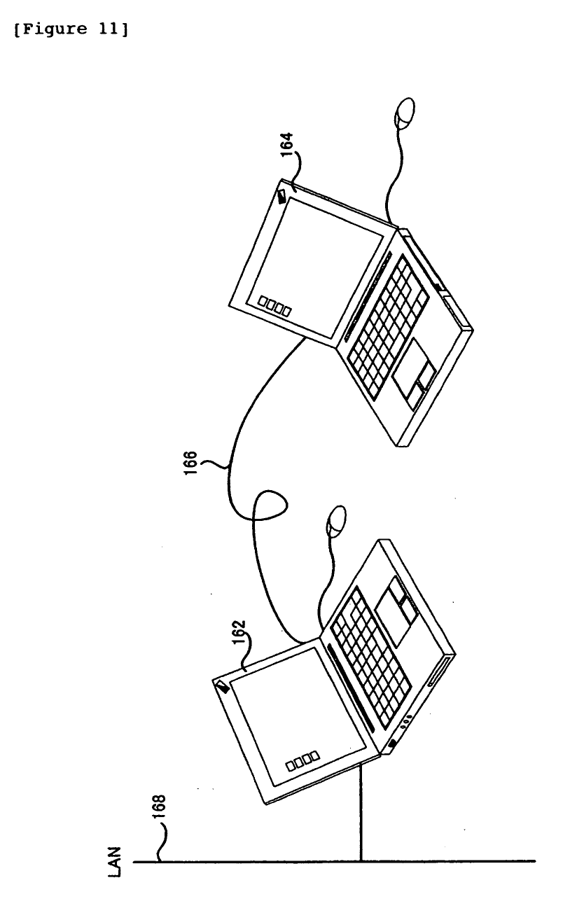

FIG. 11 shows an embodiment of a data transmission system for performing the minimum unit of the data transmission method of the present invention. A master information processor 162 is, for example, a laptop personal computer of a user, which is already connected to a network (LAN) 168 and in use for work. A slave information processor 164 is a laptop personal computer newly deployed and is to be updated by the user, as it is still in the factory configuration. In such cases, even if the slave information processor 164 is connected to the LAN, it may not be recognized by the network. Unless the user performs the network configuration himself and load the necessary data from existing system in the local network. The host name and the address of the peer from which the data is to be migrated are not automatically provided, and the user must set necessary information by himself.

In the present invention, the slave information processor 164 and the master information processor 162 are connected via a cross cable 166, and setting of a network parameters between the master information processor 162 and the slave information processor is enabled while the topology appears to be P2P. A program that performs the data transmission method of the present invention is installed in advance in the master information processor 162 and the slave information processor 164 from a storage medium via downloading from a particular web site. This operation may be performed by a service engineer, for example. However, by providing a user with a storage medium in which the program for performing the data transmission method of the present invention is stored, the user can setup the slave information processor only by activating the program of the present invention while works are continued on the master information processor 162 with the program of the present invention being executed at the background.

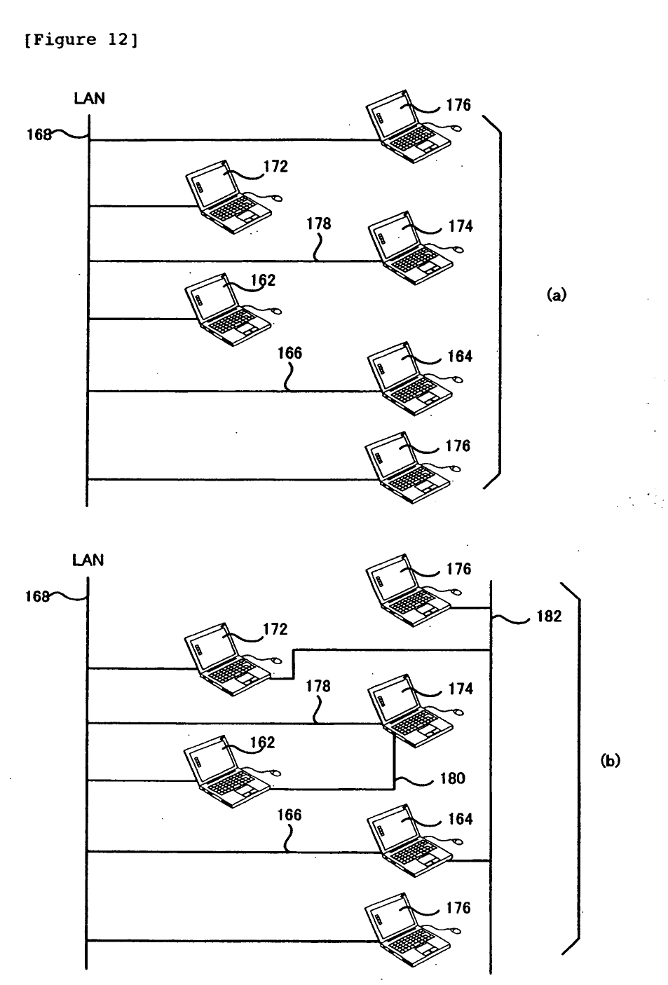

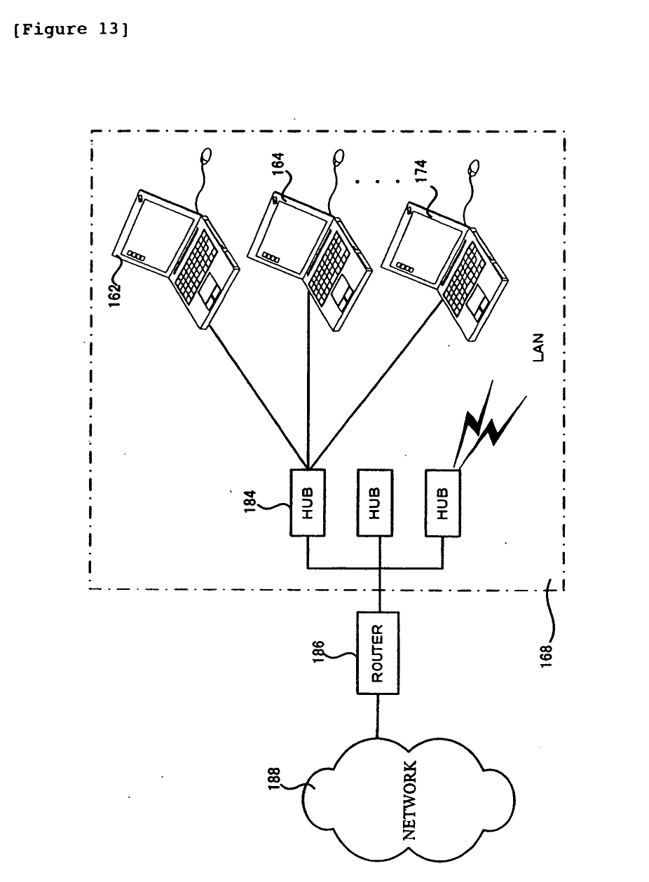

FIG. 12 shows several other embodiments of the data transmission system of the present invention. FIG. 12(a) shows a typical LAN environment in the office, and FIG. 12(b) shows an embodiment of a LAN environment in which multiple LAN 180 and 182 exist. In the embodiment shown in FIG. 12(a), there exist master/slave pairs (162, 164) and (172, 174) forming a network among multiple P2P environments in a particular LAN environment. In addition to these, there also is another information processor 176 connected to the LAN 168. In this case also, in the present invention, the slave information processor 164 which has received a connection request from the master information processor 162 identifies the master information processor 162 which has sent out the connection request, by the connection identifier and the digital signature, and sends a handshake packet to the master information processor 162. In this case, the slave information processor 164 returns its own HW address and the ID address to the master information processor 162, and thereby, the master information processor can accurately identify the slave information processor which has sent out the handshake packet and establish subsequent communication. Therefore, even when there are multiple pairs of information processors trying to establish the P2P connection in a particular LAN environment, it is possible for them to transmit network data while avoiding interference by communication with different master information processors or slave information processors.

In FIG. 12(b), there exists an information processor 176 connected not only to a LAN 168 but also a LAN 182, which is not a master information processor nor a slave information processor. A slave information processor 174 is connected to a master information processor 162 not only with a wired LAN 168 but also with a wireless LAN 180. The master information processor 162 and the slave information processor 164, which are a master/slave pair in the present invention, are both connected to the LAN 182. Even in this case, each master information processor and each slave information processor of the present invention can receive a connection request from a master information processor in the same LAN to which each of the master information processors and slave information processors is connected. The slave information processors 164 and 174 can return a handshake packet to the corresponding master information processors 162 and 172, respectively, with interference prevented.

FIG. 13 shows another preferred embodiment of the data transmission system of the present invention. In the embodiment shown in FIG. 13, a master information processor 162 and multiple slave information processors 164 to 174 are members connected a LAN 168 with hub 184. The LAN 168 is connected to an external network 188 such as the Internet or a wide area network (WAN) via a router 186. As shown in FIG. 13, the LAN may include information processors connected thereto with a wireless communication devices or infrared communication devices.

In the embodiment shown in FIG. 13, the UDP is chosen as the format of a connection request packet, a handshake packet and a handshake response packet, and one master information processor 162 transmits the information required for the connection to the network environment to the multiple slave information processors 164 to 174 via the hub 184. In the embodiment shown in FIG. 13, the master information processor connected via the hub 184 can perform the setup process of network configuration for the multiple slave information processors 164 to 174 and transmit any data required for migrating or replacing information processors, and thereby, it is possible to reduce the cost such as time and labor required for maintenance of the information processors by the end user or personnel in charge of performing a maintenance service. Even if the setup is performed by one master information processor for multiple slave information processors, the IP addresses given to the slaves are temporarily removed and can be set to any value by the user after the data transmission method of the present invention is finished. Therefore, when participating in the network again, each of the slave information processors can individually acquire a new IP address from a DHCP server or the like, and therefore the duplication of the addresses of the slave information processors at the network layer level is not caused after the participation in the network.

The information-processor-executable program to perform the data transmission method of the present invention can be implemented with various programming languages. The programming languages include object-oriented languages such as C++, JAVA®, JAVA® Applet, JAVA® Beans and JAVA® Script, for example. The executable program of the present invention may be stored in an information-processor-readable storage medium such as a floppy® disk, CD-ROM, CD-RW, DVD and MD and managed by a service engineer. Alternatively, the executable program of the present invention may be distributed with a storage medium or from a web site.

As described above, according to the present invention, it is possible to reduce costs accompanied with connection of information processors to existing network and improve efficiency of network participation process, in a network environment to which a lot of information processors are connected, such as an environment of an office.

In the drawings and specifications there has been set forth a preferred embodiment of the invention and, although specific terms are used, the description thus given uses terminology in a generic and descriptive sense only and not for purposes of limitation.

What is claimed is:

1. An information processor comprising:
a central processing unit which performs data transmission at a data link layer level for performing data transmission among information processors connected to a network;
a network adapter coupled to said central processing unit and connected to the network for performing data transmission at the data link layer level; and
a setup processing section which is coupled to the network adapter and which performs data transmission by recognizing the network adapter connected to the network, by sending out a broadcast packet to the network at the data link layer level via the recognized network adapter, by verifying a response packet transmitted via the network, and by acquiring a hardware address and an IP address from the response packet;
wherein data is transmitted at the data link layer level and a transport layer level via the recognized network adapter using the hardware address and the IP address given by the setup processing section.

2. The information processor according to claim 1, further comprising:
means for verifying that the response packet is in a predetermined format;
means for selecting the response packet in the predetermined format and acquiring the hardware address and the IP address from the selected response packet.

3. The information processor according to claim 1, wherein
a payload area of the broadcast packet includes a subnet mask.

4. An information processor comprising:
a central processing unit which performs data transmission at a data link layer level for performing data transmission among information processors connected to a network;
a network adapter which is coupled to said central processing unit and which is connected to the network for performing data transmission at the data link layer level; and
a setup processing section which performs setup for data transmission by receiving a broadcast packet at the data link layer level from the network, by verifying the broadcast packet, by generating a response packet in which an IP address generated based on the verification result is described, and by sending the response packet to the network;
wherein the information processor performs data transmission at the data link layer level and a transport layer level by letting the network adapter which has received the broadcast packet function, and using a hardware address and the IP address given by the setup processing section.

5. The information processor according to claim 4, wherein the setup processing section comprises:
means for verifying that the broadcast packet is in a predetermined format; and
means for generating the IP address if the broadcast packet is in the predetermined format and generating a response packet in which the generated IP address and a hardware address are described.

6. The information processor according to claim 4, comprising means for getting a subnet mask included in a payload area of the broadcast packet and generating the IP address using the subnet mask.

7. A method comprising:
identifying a network adapter connected to a network;
recognizing the network adapter within a memory;
sending out a broadcast packet to the network at a data link layer level via the recognized network adapter;
performing setup for data transmission by verifying a response packet transmitted via the network, and by acquiring a hardware address and an IP address from the response packet; and
letting the recognized network adapter function, and performing data transmission at the data link layer level and a transport layer level by using the acquired hardware address and the IP address.

8. The method according to claim 7, wherein the setup step comprises steps of:
verifying that the response packet is in a predetermined format;
selecting the response packet in the predetermined format if the response packet is in the predetermined format, and acquiring the hardware address and the IP address from the selected response packet.

9. The data transmission method according to claim 7, wherein the setup step comprises a step of storing a subnet mask in a payload area of the broadcast packet.

10. A method comprising:
receiving a broadcast packet which requests a response at a data link layer level, from a network;
recognizing a network adapter which has received the broadcast packet within a memory;
verifying the broadcast packet and generating a response packet in which an IP address generated based on a verification result and a hardware address are described;
letting the network adapter which has received the broadcast packet function, and sending a response packet to the network; and
performing data transmission at the data link layer level and a transport layer level using the hardware address and the IP address.

11. The method according to claim 10, wherein the generation step comprises steps of:
verifying that the broadcast packet is in a predetermined format;
generating the IP address if the broadcast packet is in the predetermined format as a result of said verification; and
storing the generated IP address in the response packet.

12. The method according to claim 10, wherein the IP address generation step further comprises a step of getting a subnet mask included in a payload area of the broadcast packet and generating the IP address using the subnet mask.

13. A data transmission system comprising:
a master information processor connected to a network for performing data transmission at the data link layer level; and
a slave information processor connected to the network for performing data transmission at the data link layer level; wherein
the master information processor recognizes a network adapter connected to the network, sends out a broadcast packet to the network at the data link layer level via the recognized network adapter, verifies a response packet transmitted via the network, and acquires a hardware address and an IP address from the response packet; and
the slave information processor receives a broadcast packet from the network at the data link layer level, verifies the broadcast packet, generates the response packet in which an IP address and a hardware address generated based on the verification result are described, and sends the response packet to the network.

14. The data transmission system according to claim 13, wherein
the master information processor is connected to the slave information processor in a configurational relationship selected from the group consisting of a counterpart of a one-to-one pair, a counterpart of one of multiple one-to-one such pairs, and the one of a one-to-N combination in the network.

15. The data transmission system according to claim 14, wherein
the data to be transmitted is selected from a group consisting of the address of a database server, the address of a printer server, the address of a mail server, the address of a DNS server, the URL address of a particular Internet site, data in a RAM managed by the master information processor, data stored in a hard disk, and a backup data, and is data for supporting a user in performing migration from the master information processor to a slave information processor to use the slave information processor.

16. A product comprising:
a computer usable medium having computer readable program code stored therein for transmitting data to a master information processor via a network, the computer readable program code in said product being effective in:
identifying a network adapter connected to the network and recognizing the network adapter within a memory;
sending out a broadcast packet to the network at a data link layer level via the recognized network adapter;
performing setup for data transmission by verifying a response packet transmitted via the network, by acquiring a hardware address and an IP address from the response packet; and
letting the recognized network adapter function, and performing data transmission at the data link layer level and a transport layer level using the hardware address and the IP address given by the setup processing section.

17. The product according to claim 16, wherein the setup comprises:
verifying that the response packet is in a predetermined format;
selecting the response packet in the predetermined format if the response packet is in the predetermined format, and acquiring the hardware address and-the IP address from the selected response packet.

18. The product according to claim 17, wherein the setup comprises: the master information processor receiving and verifying the response packet including the single IP address which is addressed to the IP address of the master information processor, each master information processor receiving and verifying the one response packet corresponding to the broadcast packet; or the master information processor receiving and verifying multiple response packets including a different IP address which are addressed to the IP address of the master information processor.

19. A product comprising:
a computer usable medium having computer readable program code stored therein for transmitting data to a slave information processor via a network, the computer readable program code in said product being effective in:
receiving a broadcast packet at a data link layer level from the network;
recognizing a network adapter which has received the broadcast packet within a memory;
verifying the broadcast packet and generating a response packet in which an IP address generated based on the verification result and a hardware address are described;
letting the network adapter which has received the broadcast packet function, and sending a response packet to the network; and
performing data transmission at the data link layer level and a transport layer level using the hardware address and the IP address.

20. The product according to claim 18, wherein the generation comprises:
verifying that the broadcast packet is in a predetermined format;
generating the IP address if the broadcast packet is in the predetermined format as a result of verification; and
storing the generated IP address in the response packet.
